(19) United States
(12) Patent Application Publication
(10) Pub. No.: US 2008/0276502 A1
(43) Pub. Date: Nov. 13, 2008

(54) CARD WITH ADHESIVE ON ITS FACES FOR THE PLACEMENT OF INFORMATION

(76) Inventors: Isaac Saad Moazeb, Tlanepantla (MX); Joe Saad Moazeb, Tlanepantla (MX)

Correspondence Address: EGBERT LAW OFFICES, 412 MAIN STREET, 7TH FLOOR, HOUSTON, TX, 77002, US

(21) Appl. No.: 11/945,971

(22) Filed: Nov. 27, 2007

(30) Foreign Application Priority Data
May 9, 2007 (MX) MX/A/2007/005575

(51) Int. Cl. G09F 1/00; A47B 97/04; B43L 1/04

(52) U.S. Cl. 40/124.01; 248/447.1; 434/408

(57) ABSTRACT

A card, cardboard, thick paper or similar material is presented as a substitute for a blackboard. The front face of the material has a series or strips of transparent adhesive or glue for the placement of graphic information. The rear face has some strips adhesive or glue for the placement on the wall. The card is protected by a film or cellophane or similar material, in order to avoid becoming stuck together. Consequently, this invention subscribes to the world of paper, and in particular, its scope of action is as an element in order to effectuate visual communication.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

This invention is used as a stationery article, and more specifically, it is used in place of a blackboard, on which graphic notices or decoration may be placed, with the characteristic of being able to use said card again resulting in a financial benefit for the user, given that there is no to use sticky tapes or adhesives which dirty or deteriorate the surfaces where the graphic information is placed.

Consequently, this invention subscribes to the world of paper, and in particular, its scope of action is as an element in order to effectuate visual communication.

2. Description of Related Art Including Information Disclosed Under 37 CFR 1.97 and 37 CFR 1.98

A blackboard is presented with a layer of card, cardboard, thick paper or similar material, which has on the front face, a series or strips of transparent adhesive or glue for the placement of graphic information, and where the lower side has two strips adhesive or glue for the placement of said cards on the wall, with the cards being protected by a film or cellophane or similar material, in order to avoid becoming stuck together.

The characteristic of counting on a series of strips of transparent adhesive on the main face, permits the placement of any graphic information. In order to take the information off, it is simply detached, and the surface may be used various times without losing adherence, serving as a blackboard substitute, while being able to use said card on various occasions. The fact that it has a film of transparent adhesive on the reverse permits the placement thereof on any smooth or rough surface, being able to detach said card from one place and to fix it to another place, without losing its adhesive properties.

This invention has a double function for the user, in that the card may be used like a blackboard with information, placing any sort of graphic information thereupon, and in turn, the information may be changed various times without the card losing its adhesive properties. Separately, the card does not require the use of adhesive tapes in order to be placed on the wall, given that the card itself has some conveniently distributed strips on the reverse side of the card, and therefore may be placed on any type of surface as well as being able to be detached from one place and placed on other surfaces, all of which does not require the use of adhesive tape.

In light of the above, this invention has the special quality of versatility, in that the card may be used various times on both sides, thereby gaining financial benefits.

### BRIEF SUMMARY OF THE INVENTION

A card, cardboard, thick paper or similar material is presented as a substitute for a blackboard, which has on the front face of the material, a series or strips of transparent adhesive or glue for the placement of graphic information, and where the lower part has some strips adhesive or glue for the placement of said cards on the wall, with the cards being protected by a film or cellophane or similar material, in order to avoid becoming stuck together.

The parts making up this layer of card are summarized as being made up of a card where the upper face has some conveniently distributed strips of gum, glue or adhesive whose function shall be to receive all kinds of notices, advertisements and graphic information; and where the rear face has only two strips of transparent gum, glue or adhesive placed towards the extremes and that serve in order to place the card on a smooth or rough surface, and where the strips of gum or adhesive are perfectly transparent with the purpose of not being able to notice the placement thereof on the surface, and therefore, the appearance of the material is completely vivid. There is a film of cellophane on the card whose function is to avoid the cards stocking together.

Consequently, this invention subscribes to the world of paper, and in particular, its scope of action is as an element in order to effectuate visual communication.

One purpose of this invention is to be able to produce cards covered with firm layers or strips of transparent adhesive or glue on its faces, without the existence of interference or marks caused by transmission between both colors when manufactured.

Another objective of this invention is to count on a card whose purpose serves to place graphic notices or information, with the characteristic of being able to be used various times and being able to place the card on smooth or rough surfaces. If so desired, it may be detached and placed on other surfaces without the need to use additional sticky or adhesive tapes.

To the best of the knowledge of the author of this invention, it is asserted that if indeed blackboards in the form of cards are already known, nobody has previously dealt with the elaboration of cards with distinct strips of transparent glue or adhesive on both sides, wherefore said invention should be deemed to be original.

### BRIEF DESCRIPTION OF THE SEVERAL VIEWS OF THE DRAWINGS

The characteristic details of this card covered with adhesive or glue, are clearly shown in the following description and the accompanying drawings as an illustration thereof and using the same signs of reference in order to indicate the parts in the shown figures.

FIG. 1 is a front view of the top side of the card.

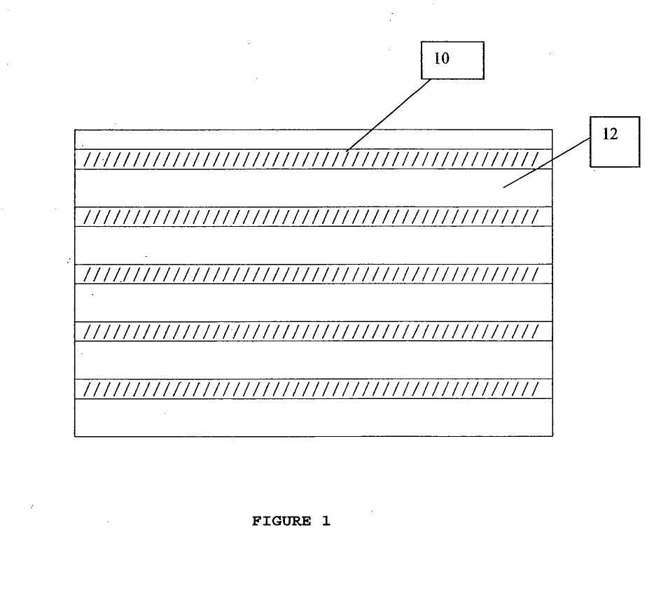

FIG. 2 is a front view of the under side of the card.

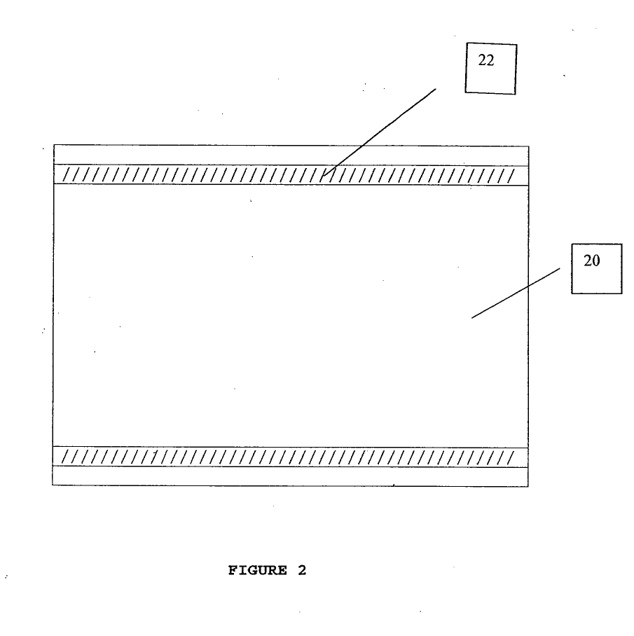

FIG. 3 is a perspective view of the top side together with the cellophane sheet.

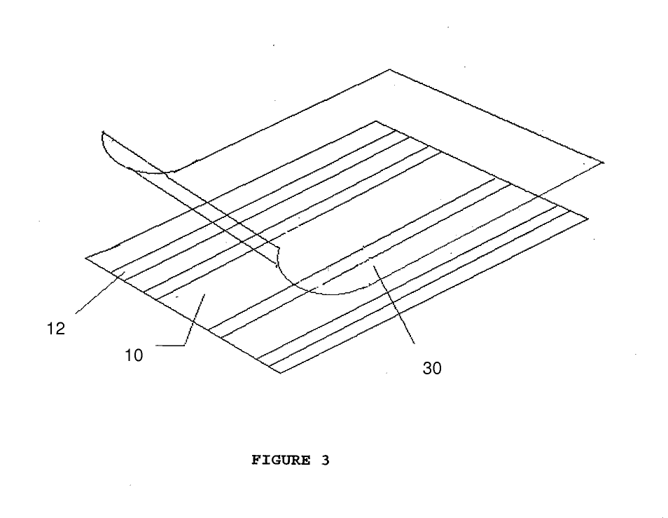

### DETAILED DESCRIPTION OF THE INVENTION

This invention refers to an original card as a substitute for a blackboard, with a covering of gum, glue or adhesive, whose characteristic enables the placement of graphic information of paper which is able to be removed in order to place new information on the top surface, and where said card may be placed on any smooth or rough surface, with the versatility of being able to be changed from one place to another without using adhesive tape.

With reference to the aforementioned figures, this invention consists of card, cardboard, thick paper or similar material, which has on the top face (10), a series or strips of transparent gum, adhesive or glue (12) with the purpose of not being able to notice the placement thereof on the surface, and therefore, the appearance of the material is completely vivid. Furthermore, said strips of gum or adhesive strips (12) are conveniently distributed in order to count on an area on the card in such a way so as to be able to place any size of notices, advertisements and graphic information in general. The rear face (20) has only two strips of transparent gum, glue or adhesive placed towards the extremes and that serve in order to place the card on a smooth or rough surface.

In order to avoid the cards sticking together, there is a cellophane film (30) adhered to the upper face (20) which is withdrawn when used.

### BEST WAY TO USE THE INVENTION

Regarding the best way to use the invention, the card is simply placed on a wall with a smooth or rough surface, pressing from the center towards the corners of the card in such a way so the glue or adhesive of the rear face (22) is firmly stuck to the surface.

The next step is to withdraw the cellophane (30), then the card is ready for the placement of any notice or graphic communication of paper.

If said information becomes obsolete or anachronistic, it is simply withdrawn and more recent information is placed thereupon, and so on.

If the notice needs to be placed in another place, the card has the versatility of being able to be changed from one place to another without using adhesive tapes.

If the card is wished to be preserved, the cellophane film (30) is again placed on the card and the card may be left on the surface or completely withdrawn. Thus, the card may be used various times.

### NOVELTY OF THE INVENTION

Having described the invention, it is deemed to be a novel invention, and therefore, the content of the following claims clause is claimed as priority.

1. Card for placement of information, comprising:
a front face being comprised of card, cardboard, thick paper or similar material;
a rear face on an opposite side of said front face;
adhesive placed on said front face, in a series or conveniently distributed strips of transparent gum, adhesive or glue, and placed on said rear face in only two strips of transparent gum, glue or adhesive placed on extreme edges of said rear face, being placed on a surface, the strips of gum being transparent; and
a film of cellophane placed said front face.
